(19) United States
(12) Patent Application Publication
(10) Pub. No.: US 2013/0068698 A1
(43) Pub. Date: Mar. 21, 2013

(54) MOBILE WATER FILTRATION UNIT

(71) Applicants: Rhys Lathlain Eddy, Glen Waverley (AU); James John Tanner, Ravenswood (AU); Rowan John Kennedy, Brighton (AU)

(72) Inventors: Rhys Lathlain Eddy, Glen Waverley (AU); James John Tanner, Ravenswood (AU); Rowan John Kennedy, Brighton (AU)

(73) Assignee: Envirostream Solutions Pty Ltd., Bendigo, Victoria (AU)

(21) Appl. No.: 13/635,891

(22) PCT Filed: Mar. 18, 2011
(86) PCT No.: PCT/AU11/00307

§ 371 Date: Nov. 30, 2012

Related U.S. Application Data
(60) Provisional application No. 61/315,134, filed on Mar. 18, 2010.
(60) Provisional application No. 61/377,677, filed on Aug. 27, 2010.

(51) Int. Cl. C02F 9/00; C02F 7/00; C02F 1/52; C02F 1/00

(52) U.S. Cl. CPC C02F 9/00; C02F 1/006; C02F 7/00; C02F 1/52; C02F 1/001
USPC 210/723; 210/416.1; 210/150; 210/232; 210/198.1; 210/323.1; 210/241

(57) ABSTRACT

A water filtration unit, comprising: a housing; a passive separator in the housing to receive a pressurized source of particulate-heavy water, to separate most of the particulate mass from the water and to output particulate-lean water; particulate egress means disposed at least partly within the housing to receive, and allow disposal of, the particulate separated from the water; at least one filtration module in the housing to each receive the particulate-lean water simultaneously, to filter remaining particulate and contaminants from the particulate-lean water by allowing passage of the water through porous filtration media of each module under gravity; and at least one outlet conduit coupled to an outlet in a wall of the housing to receive filtered water from the filtration modules and provide the filtered water to a fluid sink outside the housing.

### TECHNICAL FIELD

Described embodiments relate generally to water filtration units suitable for filtering particulate from particulate-heavy water. In particular, embodiments relate to water filtration units that are containerized for facilitating transport to a site where particulate-heavy water is to be filtered.

### BACKGROUND

In some construction and mining sites, it may be necessary to extract water from a particular area of the site and dispose of the water in an environmentally safe manner. Water having a relatively large amount of particulate suspended therein can be problematic to dispose of because normal stormwater systems may not be designed to cope with the large amount of particulate that may settle from such water as it passes through the stormwater drainage system. Additionally, the water may contain environmental pollutants that are not suitable for disposal into the stormwater system. The alternative of storing of such particulate-heavy water on site may involve substantial additional expense.

It is desired to address or ameliorate one or more shortcomings or disadvantages of existing methods or systems for dealing with water to be extracted from industrial sites, such as construction or mining sites, or to at least provide a useful alternative to such methods or systems.

### SUMMARY

Some embodiments relate to a water filtration unit, comprising:
a housing;
a passive separator in the housing to receive a pressurized source of particulate-heavy water, to separate most of the particulate mass from the water and to output particulate-lean water;
particulate egress means disposed at least partly within the housing to receive, and allow disposal of, the particulate separated from the water;
at least one filtration module in the housing to each receive the particulate-lean water simultaneously, to filter remaining particulate and contaminants from the particulate-lean water by allowing passage of the water through porous filtration media of each module under gravity; and
at least one outlet conduit coupled to an outlet in a wall of the housing to receive filtered water from the filtration modules and provide the filtered water to a fluid sink outside the housing.

The at least one filtration module of the filtration unit may comprise a plurality of filtration modules and at least one plenum may receive filtered water passing from the filtration modules and channel the filtered water to the at least one outlet conduit. The filtration unit may further comprise separate fluid conduits to deliver the particulate-lean water to respective filtration modules. The separator may be a vortex separator.

The filtration unit may further comprise a manifold tank to receive the particulate-lean water from the separator and provide the particulate-lean water to the at least one filtration module. The manifold tank may comprise a diffuser plate to spread hydrodynamic load of particulate-lean water entering the manifold tank.

The filtration unit may further comprise a filter module ingress conduits which may provide the particulate-lean water from the manifold tank to the at least one filtration module, wherein the ingress conduits may be coupled to a respective at least one filtration module and are readily decoupleable therefrom.

A length of each filter module ingress conduit may extend along or adjacent one of first and second side walls of the housing and may be supported relative to the respective first or second side wall. Each filter module ingress conduit may have a flexible conduit portion at an end of the conduit where it may be coupled to a respective one of the at least one filtration module.

The separator, the particulate egress means and the manifold tank may be formed as a processing assembly for installation in the housing as a unit. The processing assembly may comprise a support frame to support and affix the processing assembly relative to the housing.

Some embodiments relate to a method of filtering water using a filtration unit of the above described type, including the step of adding a flocculent to the particulate-heavy water.

Other embodiments relate to a water filtration unit, comprising:
a housing;
a passive separator in the housing to receive a pressurized source of particulate-heavy water and flocculent, to mix the particulate-heavy water and flocculent and separate most of the particulate mass from the water and to output particulate-lean water;
particulate egress means disposed at least partly within the housing to receive, and allow disposal of, the particulate separated from the water;
at least one filtration module in the housing to each receive the particulate-lean water from the separator simultaneously, to filter remaining particulate and contaminants from the particulate-lean water by allowing passage of the water through porous filtration media of each module under gravity; and
at least one outlet conduit coupled to an outlet in a wall of the housing to receive filtered water from the filtration modules and provide the filtered water to a fluid sink outside the housing.

The filtration unit may further comprise flocculent injection means inside the housing to add flocculent to the pressurized source of particulate-heavy water. The filtration unit may further comprise treatment chemical injection means inside the housing to add treatment chemicals to the pressurized source of particulate-heavy water to offset changes in pH of the water due to the addition of flocculent so as to generally maintain the pH of the particulate-heavy water. At least one of the flocculent injection means and the treatment chemical injection means may be a dosing pump. The flocculent may be aluminium sulphate.

The filtration unit may further comprise a clarifier disposed between the separator and the at least one filtration module for receiving the particulate-lean water from the separator to further settle flocs therein and provide particulate-lean water to the at least one filtration module. The clarifier may be a lamella clarifier.

The filtration unit may further include a weir to receive particulate-lean water from the clarifier and provide the particulate-lean water to the at least one filtration module.

The filtration unit may further include a launder to receive particulate-lean water from the weir and provide the particulate-lean water to the at least one filtration module.

The at least one filtration module may comprise a plurality of filtration modules and at least one plenum to receive filtered water passing from the filtration modules and channel the filtered water to the at least one outlet conduit. The filtration unit may further comprise separate fluid conduits to deliver the particulate-lean water to respective filtration modules. The separator may be a vortex separator.

The separator, the clarifier, the weir and the launder may be formed as a processing assembly for installation in the housing as a unit. The processing assembly may comprise a support frame to support and affix the processing assembly relative to the housing.

The at least one filtration module of the filtration unit may be configured to be readily replaceable with another at least one filtration module containing fresh or regenerated porous filtration media.

The housing may have at least one openable door sized to allow the insertion and withdrawal of the at least one filtration module during replacement. The housing may comprise a container transportable using standard shipping container transport means.

The container may have a rectanguloid shape, with a length greater than a height and width of the container, and may have a floor, a ceiling, side walls extending lengthwise, a back wall and an opposed front wall defined by at least one openable door.

The filtration unit may further comprise a bund floor positioned intermediate the at least one filtration module and the floor to channel the filtered water to the at least one outlet conduit. The bund floor may comprise a series of rollers to facilitate passage of the at least one filtration module across the bund floor.

The separator and particulate egress means may be disposed toward or adjacent the back wall and the at least one filtration module may be disposed between the separator and the front wall.

The source of particulate-heavy water may be received through an inlet formed in the back wall and the outlet may be disposed in the back wall.

The separator may receive the particulate-heavy water at a rate of about 10 liters/second.

The particulate egress means may comprise means to collect the separated particulate and allow removal of the particulate from the housing.

A total upper surface area of the porous filtration media of the at least one filtration module may be between about 4 m² and about 8 m². The separator may separate most particles of the particulate that are greater than about 150 microns in size.

Some embodiments relate to a water filtration system comprising one or more water filtration units as described above in combination with means to provide the pressurized water, means to dispose of separated particulate and a water sink for the filtered water.

Some embodiments relate to a method of filtering water using a filtration unit as described above, including the step of adding a flocculent to the particulate-heavy water.

### BRIEF DESCRIPTION OF THE DRAWINGS

Embodiments are described in further detail below, by way of example, with reference to the accompanying drawings. In the accompanying drawings:

FIG. 1 is a perspective view of a water filtration unit according to some embodiments, shown for illustration purposes without some walls;

FIG. 2 is a plan view of the water filtration unit, shown for illustration purposes without a roof;

FIG. 3 is a side elevation of the water filtration unit, as seen through a side wall;

FIG. 4 is a partial cutaway perspective view of a separation assembly forming part of the water filtration unit;

FIG. 5A is a perspective view of a standard intermediate bulk container (IBC);

FIG. 5B is a perspective view of an example water filtration module;

FIG. 6 is a perspective view of part of the water filtration unit, showing the filter modules removed and illustrating bund floors of the unit in further detail;

FIG. 7 is a schematic representation of a water filtration system that employs a water filtration unit according to FIG. 1;

FIG. 8 is a perspective view of a water filtration unit according to other embodiments, shown for illustration purposes without some walls;

FIG. 9 is a side elevation of the water filtration unit of FIG. 8, as seen through a side wall;

FIG. 10 is an end elevation of the water filtration unit of FIG. 8, as seen through an end wall;

FIG. 11 is an end elevation of the water filtration unit of FIG. 8;

FIG. 12 is a system diagram for the water filtration unit of FIG. 8;

FIG. 13 is a perspective view of a water filtration unit according to other embodiments, shown for illustration purposes without some walls; and

FIG. 14 is a side elevation of the water filtration unit of FIG. 8, as seen through a side wall.

### DETAILED DESCRIPTION

Described embodiments relate generally to water filtration units suitable for filtering particulate from particulate-heavy water. In particular, embodiments relate to water filtration units that are containerized for facilitating transport to a site where particulate-heavy water is to be filtered.

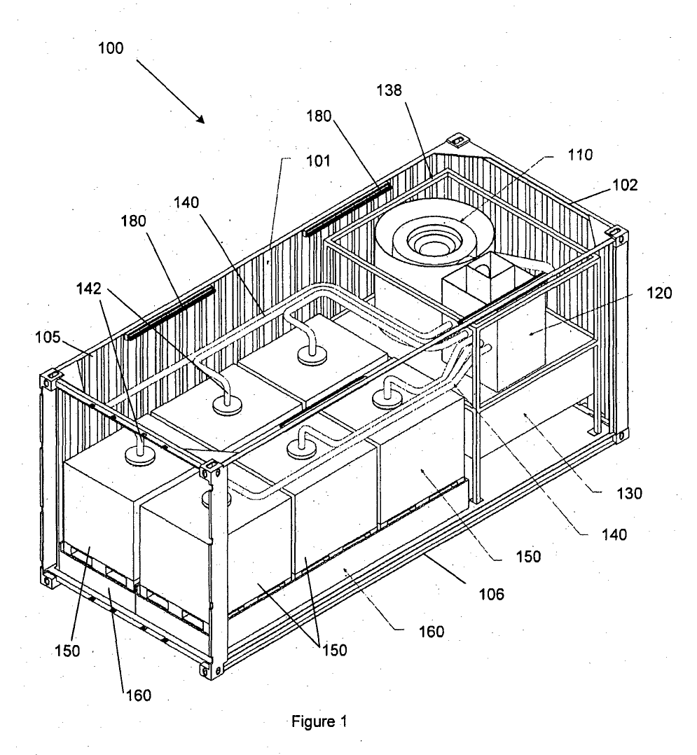

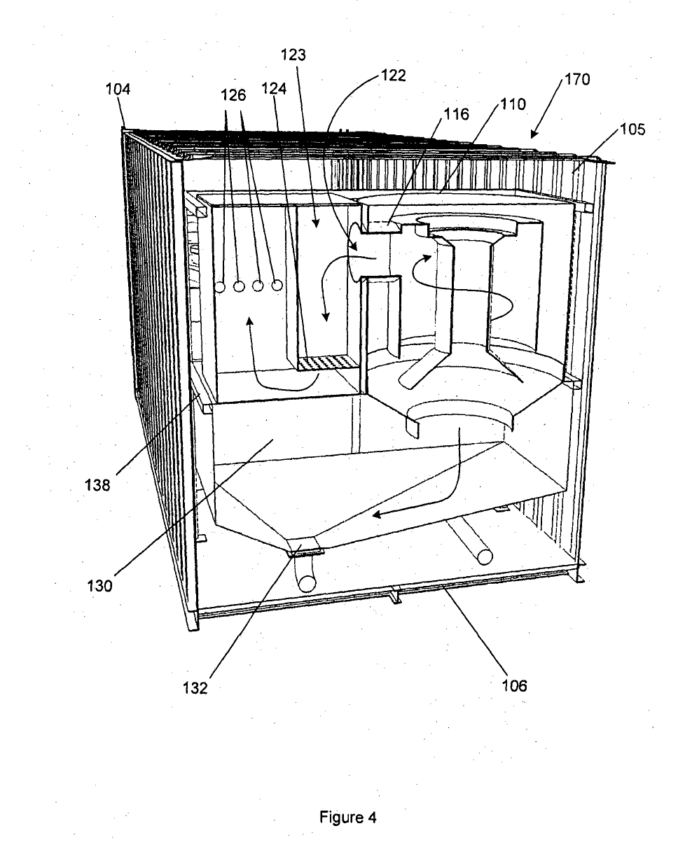

As shown in FIGS. 1 to 4, 5B and 6, described embodiments relate generally to a water filtration unit 100 comprising a housing 101, which may be in the form of a standardized shipping container, to house the various components described below. Water filtration unit 100 comprises a separator 110, a manifold tank 120, particulate egress means including a particulate storage plenum 130 and at least one egress conduit and/or aperture, fluid transfer conduits 140, one or more filtration modules 150 and at least one bund floor 160, all of which are disposed in the housing 101.

The separator 110 receives particulate-heavy water via an inflow conduit 114 running between a body of the separator 110 and an inlet port 112 positioned in a back wall 102 of the housing 101. The particulate-heavy water may also include or carry with it oils or other floating pollutants that are desired to be separated from the water. The separator 110 may be a vortex separator, for example of the type known as Downstream Defender™, which is a product of Hydro International. The separator 110 thus receives the particulate-heavy water under pressure at a rate of up to about 20 liters/sec, say 5 to 20 liters/sec, for example, and passively separates most (around 90%) of the particulate greater than about 150 microns in size from the water and/or other liquids carried with the water. The resulting particulate-lean water (possibly including other liquids) is then provided to an outlet 116 of the separator 110 to manifold 120, passing through an inlet aperture 122 of the manifold tank 120.

The particulate separated (settled) from the water by separator 120 is allowed to fall under gravity out of a lower aperture of the separator 120 and into the particulate storage hopper or plenum 130 before subsequent extraction through a lower opening 132 of the plenum 130. Depending on the particular site at which the water filtration unit 100 is employed, the type of particulate in the water may have different characteristics, requiring more or less frequent evacuation of the particulate collected in storage plenum 130. In some embodiments, opening 132 may open directly to a large hopper or further plenum positioned beneath water filtration unit 100 for frequent removal of the accumulating particulate. In other embodiments, a pump may be used to actively extract the particulate from plenum 130 via opening 132 and then through an outlet conduit 133 communicating to an outlet port 134 positioned in a lower part of the back wall 102.

Manifold tank 120 provides a plenum function to allow distribution of particulate-lean water received from separator 110 into fluid transfer conduits 140 for distribution to the filtration modules 150. Manifold tank 120 receives the particulate-lean water through inlet aperture 122 into an inlet plenum 123 at the bottom of which is a diffuser plate 124. The diffuser plate 124 has a series of holes to allow the particulate-lean water to pass therethrough into a main plenum volume of the manifold tank 120 and functions to spread the hydrodynamic load and thus reduce the inertia of the water as it passes into the main plenum volume. Six outlet apertures 126 are formed in one wall of the manifold tank 120, with each aperture communicating with one of the six fluid transfer conduits 140 to communicate the particulate-lean water to six filtration modules 150 in a relatively even manner. Other embodiments may use fewer or greater than six filtration modules, and a corresponding one-to-one reduction or increase in the number of fluid transfer conduits 140 and outlet apertures 126 may be required.

As shown in the drawings, the six filtration modules 150 are arranged in two rows of three modules side by side. Each row of three filtration modules 150 is adjacent a wall of housing 101 on one side and the other row of filtration modules 150 on the other side. Each row of filtration modules 150 is positioned on a separate bund floor 160 having sets of rollers 165 for allowing easy insertion and removal of each filtration unit 150 from within housing 101.

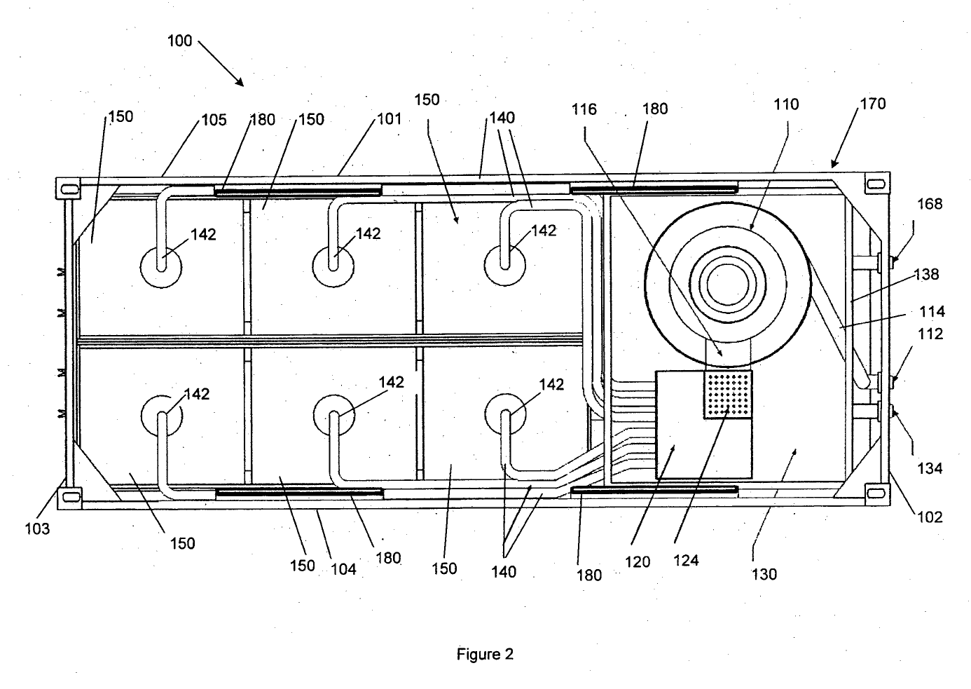

To allow for convenient access while coupling and decoupling conduits 140 to each of the filtration modules 150, a length of each conduit 140 is positioned along and supported relative to a part of housing side wall 105 or 104. This allows the side walls 104, 105 of housing 101 to support the conduits 140 while allowing a flexible coupling portion 142 at an outlet end of each conduit 140 to be positioned for coupling to an inlet of each filtration module 150. As shown in FIGS. 1 and 2, three conduits 140 pass at least partly along or adjacent wall 105, while the other three conduits 140 pass at least partly along or adjacent wall 104, with each conduit 140 branching inwardly from the adjacent wall 104, 105 and then downwardly to couple with a respective filtration module 150. In alternative embodiments, conduits 140 may be fixed (i.e. suspended) relative to the roof 107 rather than the walls 104,105.

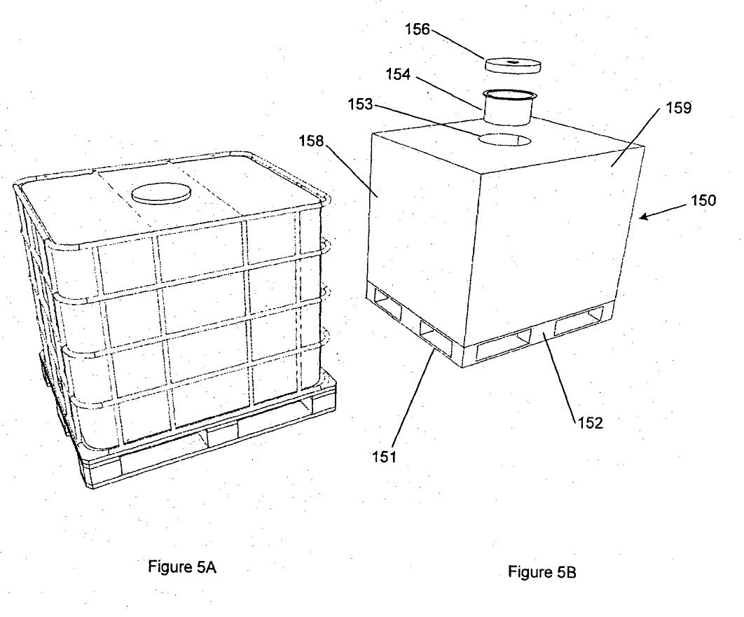

Filtration modules 150 are shown in further detail, but by way of example only, in FIG. 5B. Each filtration module 150 may be sized approximately to be structurally and volumetrically similar to a standard immediate bulk container (IBC). Filtration modules 150 may have base dimensions of 1,000 millimeters by 1,200 millimeters, with a height of 1,120 millimeters for filtration module embodiments designed to emulate an IBC. A standard IBC is shown in FIG. 5A for comparison.

Each filtration module 150 comprises porous filtration media 158 having a depth X that may range from about 400 millimeters to about 800 millimeters, depending on filtration requirements. Porous filtration media 158 is entirely enclosed within a module housing 159 that has an inlet housing 153 positioned centrally on an upper face of the housing 159. Received within the inlet aperture 153 is a perforated diffuser bucket 154 with a series of holes in a bottom wall thereof to spread the flow of incoming water from conduit 140. The flexible pipe coupling 142 at the outlet end of each conduit 140 can be coupled to each filtration module 150 using suitable coupling means, for example including a clip fastener coupling provided in a screw-on cap 156 fitted over the top of diffuser bucket 154. This clip fastener coupling is designed to be readily decoupleable in order to allow each filtration module 150 to be changed out for a module that has fresh or regenerated porous filtration media 158.

Each filtration module 150 has a base 152 through which water passing through porous filter media 158 drains on to bund floor 160. Base 152 preferably has two openings at each side to be able to receive two lifting tines of a forklift during withdrawal or insertion of the filter module from housing 101. Filter module base 152 thus needs sufficient structural rigidity to support the weight of the filter housing 159 and porous filter media 158, as well as allowing handling of the filter module 150 by a forklift. Additionally, a bottom plate or sheet 151 of base 152 is perforated or may be at least partly formed as a mesh. In some embodiments, base 152 may be formed predominantly of a strong structural moulded plastic. In other embodiments, the base 152 may be made of a structural metal or a combination of metal and plastic support structures. In any case; the base 152 needs to have sufficient structural integrity to support the weight of the module 150 when it is at its heaviest (i.e. full of water).

For six filtration modules 150 each having an upper surface area (of porous filter media 158) of about 1.2 m², the total upper surface area is about 7.2 m², although different configurations may vary between about 4 m² and about 8 m².

The porous filter media 158 is of a kind that filters out most silt and suspended solids, as well as removing oils, other non-aqueous liquids and dissolved pollutants, such as nutrients and/or heavy metals, in an amount sufficient to render the filtered water environmentally safe for further use or disposal to stormwater drainage. Examples of porous filter media 158 that can be used in filtration module 150 are described in Australian provisional patent application no. 2009903796 entitled “Treatment”, the entire disclosure of which is incorporated herein by reference.

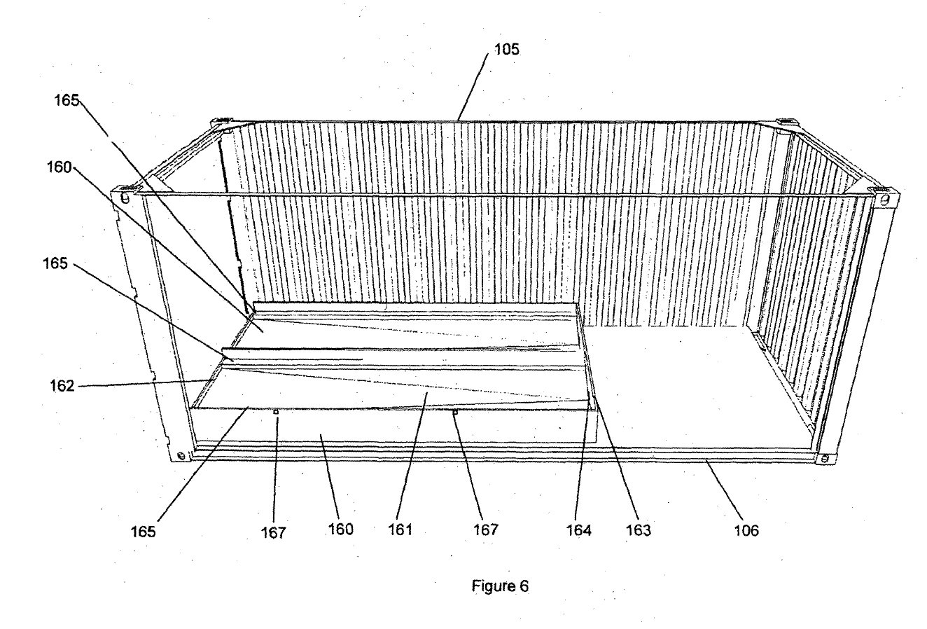

Referring now to FIG. 6, bund floors 160 are shown in further detail. Although FIG. 6 shows two separately formed bund floors 160 positioned side by side to support the two rows of filtration modules 150, a single bund floor or more than two bund floors could be formed instead. Each bund floor 160 may act as a secondary sediment trap.

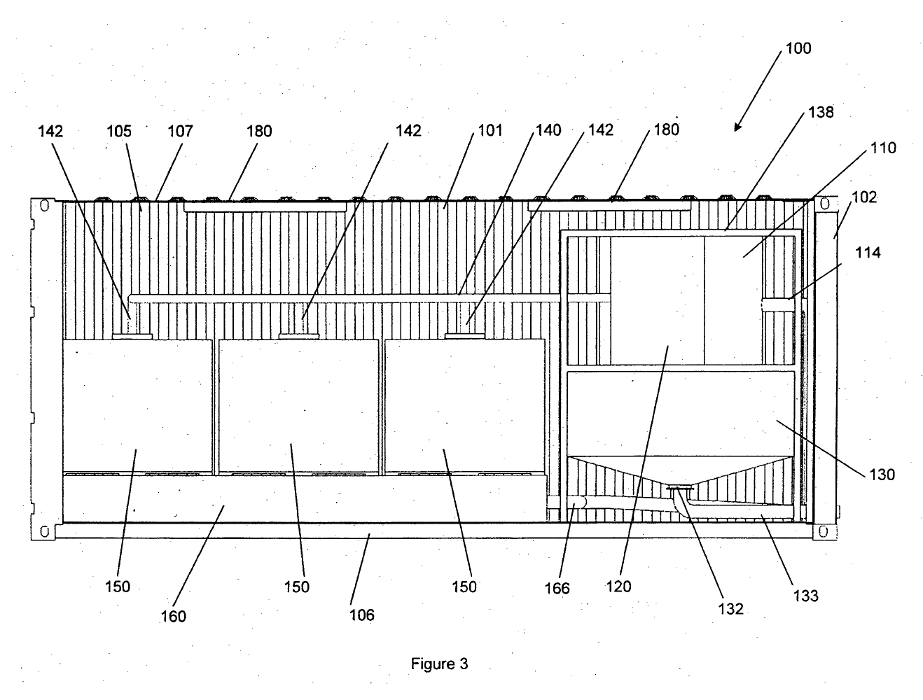

As shown in FIG. 6, each bund floor 160 has a sloped and inwardly angling surface 161 to collect and channel filtered water from the filtration modules 150 toward an outlet aperture 164 formed in a low part of a back wall 163 of the bund floor 160. The sloping surface 161 slopes gradually downwardly from adjacent a front wall 162 of the bund floor 160 toward the back wall 163. Outlet aperture 154 is fluidly coupled to a filtered water outlet conduit 166 (FIG. 3), which fluidly communicates with a filtered water outlet port 168 positioned in back wall 102.

Rollers 165 are also provided along each long side of each bund floor 160 to enable each filtration module 150 to be easily slid on or off the bund floor 160. The rollers 165 are configured to support opposed side edges of base 152 of each filtration module 150 so as not to deter or obstruct water collection via the sloped surface 161.

Each bund floor 160 may have securing means to secure each filtration module 150 in place during transport of the housing 101. This securing means may include raised side flanges on each lengthwise side of each bund floor 160, together with spaced tie down points 167 positioned along the side flanges.

Bund floors 160 may rest directly on floor 106 of housing 101 or may be cushioned by some intermediate material. Bund floors 160 are preferably securely (but removably) fastened in position relative to the housing floor 106 and walls 104, 105. The front end 162 of each bund floor 160 is positioned adjacent the front wall 103 of housing 101 which opens up as at least one hinged door for convenient loading or removal of the filtration modules 150 onto each bund floor 160.

In some embodiments, the separator 110, manifold tank 120 and particulate egress means including storage plenum 130 may be formed as a single assembly supported by a frame 138 for installation within housing 101 as a single unit.

Housing 101 may further comprise lighting means 180 positioned on a wall 104, 105 or roof 107 for illuminating the inside of housing 101. Such lighting means 180 may comprise lighting that is powered by a local battery or other power source or, alternatively, the lighting means 180 may be powered by electrical circuitry fed by an external power supply coupled to a power supply input provided in or on housing 101.

While water filtration unit 100 is generally designed to operate in a passive manner (i.e. not requiring the supply of power to enable the operation of the water filtration unit 100), some embodiments may employ some powered components, such as the lighting and/or one or more pumps, for example to expel separated particulate and/or filtered water. Otherwise, embodiments generally rely on gravity and the kinetic energy of water supplied to separator 110 under pressure. Thus, apart from incidental electrical energy used for lighting means 180, embodiments not employing any internal pumps may receive the kinetic energy of the incoming particulate-heavy water as the only form of energy input to the whole filtration system. The water filtration unit 100 of some embodiments is thus appropriately characterized as passive because there is no need for it to be powered. On the other hand, water filtration unit 100 does rely on a water source that is pressurized either by an external pump or due to sufficient head of water under gravity.

Use of a shipping container as the housing 101 for some embodiments of water filtration unit 100 advantageously allows for ease of transport of the water filtration unit 100 using transportation means that is normally adapted to transport shipping containers. In some embodiments, housing 101 may be formed by modifying an existing shipping container to have appropriate inlet/outlet apertures access doors, electrical supply circuits (if lighting means 180 and/or pumps are used) and other means for fixing the various components in position for transport. If a retrofitted or newly fabricated (modified) shipping container is used, then the resulting housing 101 will have the normal side walls, floor, roof, back wall and front wall, with the front wall also functioning as a door.

In other embodiments, housing 101 may be formed to have dimensions and handling characteristics of a standard shipping container, but may be formed of at least some lighter and/or non-metallic housing materials. For example, some embodiments may employ a steel frame structure, with one or more of the walls, floor and roof being formed of a lighter material, such as moulded plastic and/or aluminum supports or frame components.

Although not shown, housing 101 may have one or more access doors formed in a side wall 104, 105, back wall 102, roof 107 or floor 106.

Inlet port 112 and outlet ports 134, 168 may comprise standard high capacity pump connections, for example.

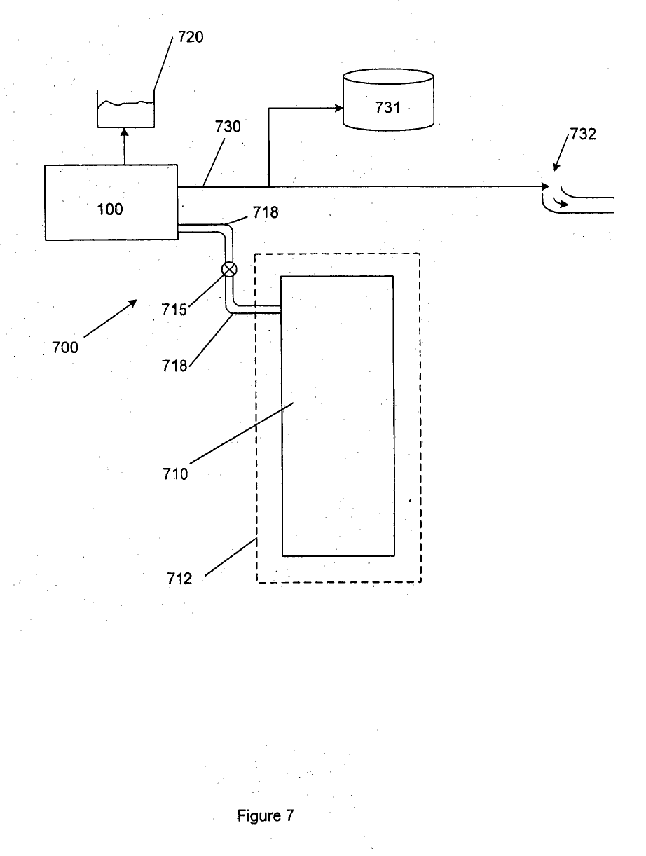

Referring now to FIG. 7, there is shown a system 700 for water filtration at a site 712. Water filtration unit 100 may be used to filter a body of water 710 present at site 712 by pumping the particulate-heavy water along a conduit 718 using a pump 715 to provide the particulate-heavy water at a rate of about 10 liters per second into separator 110 via inlet 112 and conduit 114. Once the water is filtered, the separated particulate may be transferred into a hopper 720 for further disposal and the filtered water from outlet 168 may be provided to an external conduit 730 to carry the filtered water to a destination (water sink) such as storage 731, a stormwater or sewer drain 732 or to otherwise dispose of the water in a responsible manner.

Some embodiments of system 700 may include multiple water filtration units 100 operating in parallel and receiving the particulate-heavy water from a single source or multiple separate sources.

System 700 may comprise multiple water filtration modules 100 operating in parallel and positioned side-by-side or one on top of another.

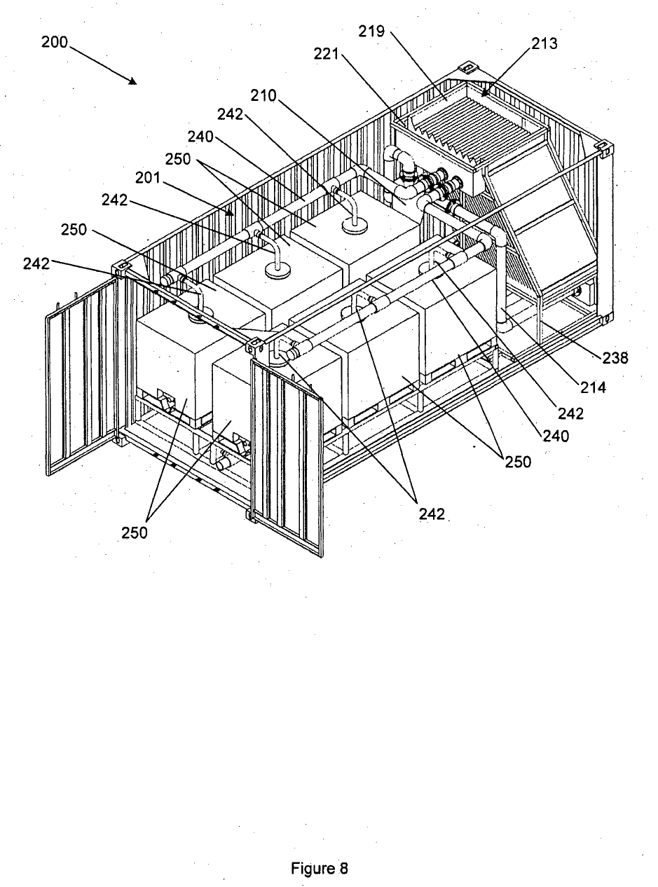

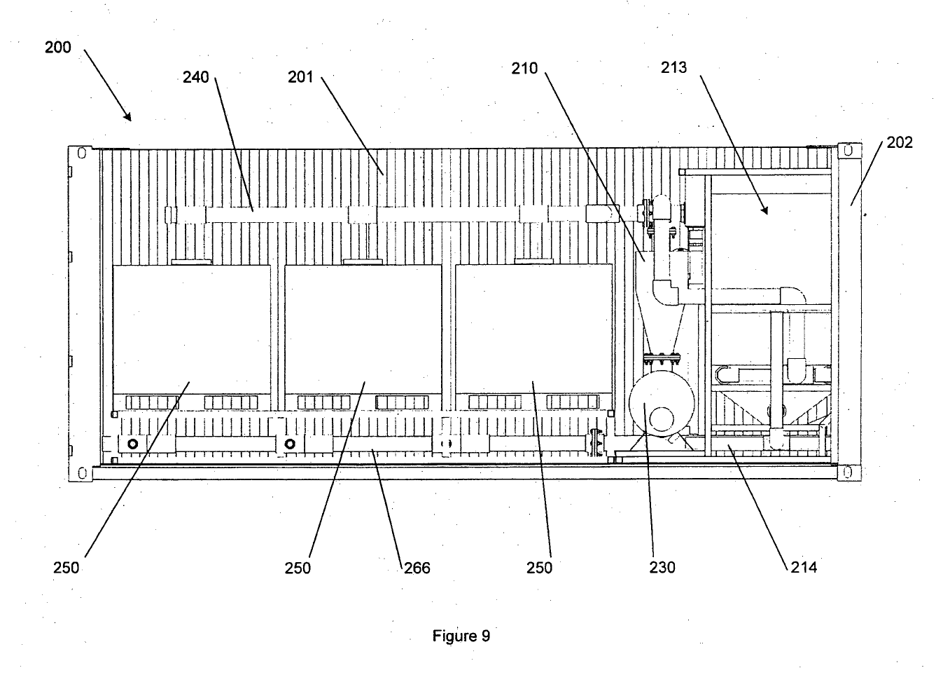

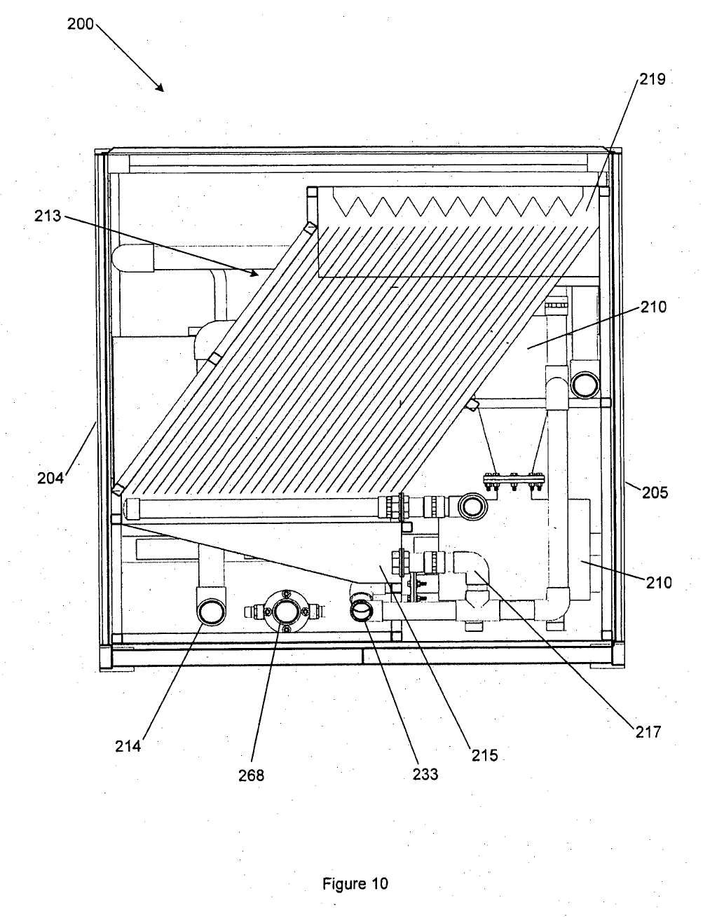

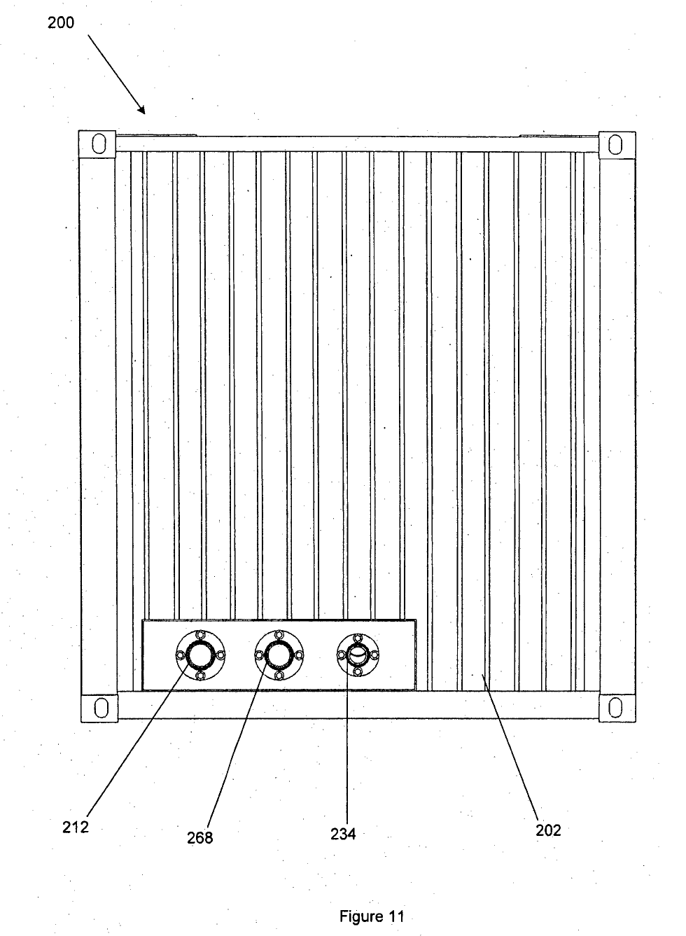

As shown in FIGS. 8 to 11, other described embodiments relate generally to a water filtration unit 200 comprising a housing 201, which may be in the form of a standardized shipping container, to house the various components described below. Water filtration unit 200 comprises a separator 210, particulate egress means including a particulate storage conduit plenum 230 and at least one egress conduit and/or aperture, fluid transfer conduits 240 and one or more filtration modules 250, all of which are disposed in the housing 201.

The separator 210 receives particulate-heavy water via an inflow conduit 214 running between a body of the separator 210 and an inlet port 212 positioned in a back wall 202 of the housing 201. The particulate-heavy water may also include or carry with it oils or other floating pollutants that are desired to be separated from the water. The separator 210 may be a vortex separator, for example of the type known as Downstream Defender™, which is a product of Hydro International. The separator 210 thus receives the particulate-heavy water under pressure at a rate of up to about 20 liters/sec, say 5 to 20 liters/sec, for example, and passively separates most (around 90%) of the particulate greater than about 150 microns in size from the water and/or other liquids carried with the water. The separator removes coarse sediment and larger particles, such as stones and sand, from the particulate-heavy water. The resulting particulate-lean water (possibly including other liquids) is then provided to a clarifier 213, which in the embodiment shown is a lamella clarifier.

Flocculent is added to the particulate-heavy water before it reaches the separator 210. The flocculent is added by way of a flocculent injection means (not shown), which may include, for example, a dosing pump. The separator 210 causes rapid mixing of the flocculent and the particulate-heavy water, improving the formation of flocs.

The particulate separated (settled) from the water by separator 210 is allowed to fall under gravity out of a lower aperture of the separator 210 and into the particulate storage hopper or plenum 230 before subsequent extraction. Depending on the particular site at which the water filtration unit 200 is employed, the type of particulate in the water may have different characteristics, requiring more or less frequent evacuation of the particulate. In some embodiments, storage hopper or plenum 230 may open directly to a large hopper or further plenum positioned beneath water filtration unit 200 for frequent removal of the accumulating particulate. In other embodiments, a pump may be used to actively extract the particulate from plenum 230 through an outlet conduit 233 communicating to an outlet port 234 positioned in a lower part of the back wall 202.

Particulate-lean water is provided from the separator 210 to the clarifier 213. The clarifier includes a large tank with a plurality of flat plates or similar elements laid inside the tank on an angle between 40 and 70 degrees. This increases the effective settling area and improves the sedimentation performance. Sediment in the clarifier 213 collects inside a lower tank 215 and is directed via conduit 217 toward outlet conduit 233. The tank provides a smooth, low velocity flow condition which allows flocs to form and settle out of the water column. The particulate-lean water leaves the clarifier via a weir 219 and a launder 221 which collects the water for distribution into the filtration modules. The filtration modules remove any remaining flocs that have not been settled out, as well as any dissolved pollutants such as nutrients and heavy metals and adjust the pH of the water. The use of clarifier 213, weir 219 and launder 221 may allow the size of the separator to be reduced.

Fluid transfer conduits 240 communicate the particulate-lean water to six filtration modules 250 in a relatively even manner. Other embodiments may use fewer or greater than six filtration modules.

As shown in the drawings, the six filtration modules 250 are arranged in two rows of three modules side by side. Each row of three filtration modules 250 is adjacent a wall of housing 201 on one side and the other row of filtration modules 250 on the other side. Each row of filtration modules 250 may be positioned on rollers for allowing easy insertion and removal of each filtration unit 250 from within housing 201.

To allow for convenient access while coupling and decoupling conduits 240 to each of the filtration modules 250, a length of each conduit 240 is positioned along and supported relative to a part of housing side wall 205 or 204. This allows the side walls 204, 205 of housing 201 to support the conduits 240 while allowing a flexible coupling portion 242 at an outlet end of each conduit 240 to be positioned for coupling to an inlet of each filtration module 250. As shown in FIG. 8, three conduits 240 pass at least partly along or adjacent wall 205, while the other three conduits 240 pass at least partly along or adjacent wall 204, with each conduit 240 branching inwardly from the adjacent wall 204, 205 and then downwardly to couple with a respective filtration module 250. In alternative embodiments, conduits 240 may be fixed (i.e. suspended) relative to the roof 207 rather than the walls 204,205.

Filtration modules 250 may be the same as those shown in FIG. 5B and described above with reference to filtration module 150. Each filtration module 250 is in fluid communication with a filtered water outlet port 268 which is positioned in back wall 202 by outlet conduit 266.

In some embodiments, the separator 210, particulate egress means including storage plenum 230, and clarifier 213 may be formed as a single assembly supported by a frame 238 for installation within housing 201 as a single unit.

Housing 201 may further comprise lighting means (not shown) positioned on a wall 204, 205 or roof 207 for illuminating the inside of housing 201. Such lighting means, may comprise lighting that is powered by a local battery or other power source or, alternatively, the lighting means may be powered by electrical circuitry fed by an external power supply coupled to a power supply input provided in or on housing 201.

While water filtration unit 200 is generally designed to operate in a passive manner (i.e. not requiring the supply of power to enable the operation of the water filtration unit 200), some embodiments may employ some powered components, such as the lighting and/or one or more pumps, for example to expel separated particulate and/or filtered water. Otherwise, embodiments generally rely on gravity and the kinetic energy of water supplied to separator 210 under pressure. Thus, apart from incidental electrical energy used for lighting means, embodiments not employing any internal pumps may receive the kinetic energy of the incoming particulate-heavy water as the only form of energy input to the whole filtration system. The water filtration unit 200 of some embodiments is thus appropriately characterized as passive because there is no need for it to be powered. On the other hand, water filtration unit 200 does rely on a water source that is pressurized either by an external pump or due to sufficient head of water under gravity.

Use of a shipping container as the housing 201 for some embodiments or water filtration unit 200 advantageously allows for ease of transport of the water filtration unit 200 using transportation means that is normally adapted to transport shipping containers. In some embodiments, housing 201 may be formed by modifying an existing shipping container to have appropriate inlet/outlet apertures access doors, electrical supply circuits (if lighting means and/or pumps are used) and other means for fixing the various components in position for transport. If a retrofitted or newly fabricated (modified) shipping container is used, then the resulting housing 201 will have the normal side walls, floor, roof, back wall and front wall, with the front wall also functioning as a door.

In other embodiments, housing 201 may be formed to have dimensions and handling characteristics of a standard shipping container, but may be formed of at least some lighter and/or non-metallic housing materials. For example, some embodiments may employ a steel frame structure, with one or more of the walls, floor and roof being formed of a lighter material, such as moulded plastic and/or aluminum supports or frame components.

Although not shown, housing 201 may have one or more access doors formed in a side wall 204, 205, back wall 202, roof 207 or floor 206.

Inlet port 212 and outlet ports 234, 268 may comprise standard high capacity pump connections, for example.

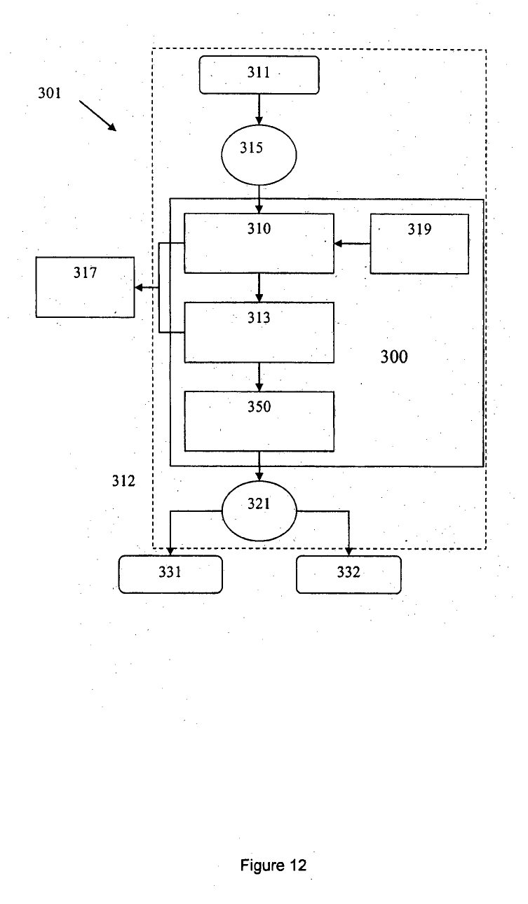

Referring now to FIG. 12, there is shown a system 301 for water filtration at a site 312. Water filtration unit 300 may be used to filter a body of water 311 present at site 312 by pumping the particulate-heavy water along a conduit using a pump 315 to provide the particulate-heavy water, to which a flocculent 319 is added, at a rate of about 20 liters per second into a separator 310.

Once the water passes through the separator 310, it passes into a clarifier 313 for further removal of particulate 317. The separated particulate 317 may be transferred and pumped away for disposal. Water then passes to filtration modules 350 for further filtration and is then provided to an external conduit via pump 321 to carry the filtered water to a destination (water sink) such as storage 331 or a waterway 332 or to otherwise dispose of the water in a responsible manner.

Some embodiments of system 301 may include multiple water filtration units 300 operating in parallel and receiving the particulate-heavy water from a single source or multiple separate sources. System 301 may comprise multiple water filtration modules 350 operating in parallel and positioned side-by-side or one on top of another.

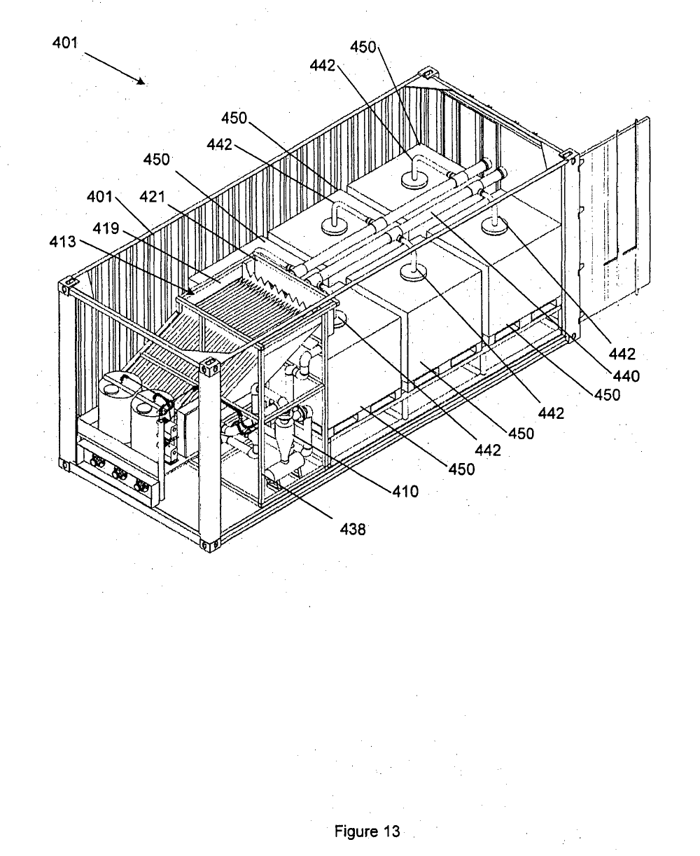

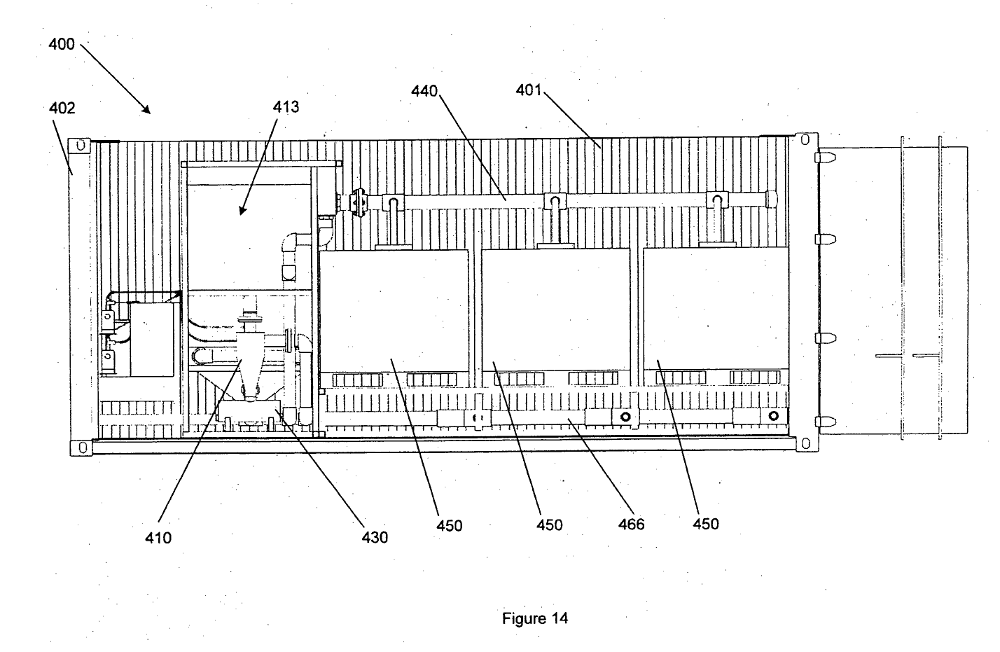

As shown in FIGS. 13 and 14, other described embodiments relate generally to a water filtration unit 400 generally in accordance with water filtration unit 200, though further comprising a treatment chemical injection means 480. Features common between water filtration unit 400 and water filtration unit 200 have been numbered using like numbers.

The treatment chemical injection means 480 is a dosing pump configured to supply treatment chemicals to offset changes in pH of the water due to the addition of flocculent so as to generally maintain the pH of the particulate-heavy water. In the described examples, aluminium sulphate is added as a flocculent and causes the pH of the particulate-heavy water to change. The treatment chemical injection means 480 adds a solution of hydrated lime and water to the particulate-heavy water to maintain a generally neutral pH level. As an alternative to lime, caustic soda may be used.

The treatment chemical injection means 480 is disposed adjacent a flocculent injection means 482. Each of the treatment chemical injection means 480 and the flocculent injection means 482 consists of a chemical tank with capacity of between 125 and 200 liters, a solenoid metering pump, a control box and an injection port. Both systems inject the treatment chemicals or flocculent into the separator 410 to aid in the mixing of the treatment chemicals or flocculent. The chemical tanks are located at the end of the housing 401 and an access door (not shown) is provided so that the tanks may be readily accessed. In comparison to water filtration unit 210, the clarifier 413 of water filtration unit 410 is repositioned to allow for fitment of the treatment chemical injection means 480 and the flocculent injection means 482.

The solenoid metering pumps are electronic and powered by a 12 volt supply from a battery which can be charged by mains power or connected to a solar system. A PLC controlled monitoring system may be used to record turbidity, pH and other parameters. A PLC control system may also be used to control the treatment chemical injection means 480 and the flocculent injection means 482.

Throughout this specification and claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A water filtration unit, comprising:
a housing;
a passive separator in the housing, wherein the passive separator is to configured to receive a pressurized source of particulate-heavy water, to separate most of the particulate mass from the water and to output particulate-lean water;
a particulate egress unit disposed at least partly within the housing, wherein
the particulate egress unit comprises a storage plenum and at least one of an egress conduit and an egress aperture, and
the particulate egress unit is configured to receive, and allow disposal of, the particulate mass separated from the particulate-heavy water;
at least one filtration module disposed in the housing, wherein
each filtration module of the at least one filtration module comprises porous filtration media, and
each filtration module is configured to receive the particulate-lean water simultaneously, and to filter remaining particulate and contaminants from the particulate-lean water by allowing passage of the particulate-lean water through the porous filtration media; and
at least one outlet conduit coupled to an outlet in a wall of the housing, wherein each outlet conduit of the at least one outlet conduit is configured to receive filtered water from the at least one filtration module and provide the filtered water to a fluid sink outside the housing.

2. The filtration unit of claim 1, further comprising a manifold tank, wherein the manifold tank is configured to receive the particulate-lean water from the separator and provide the particulate-lean water to the at least one filtration module, the manifold tank comprising a diffuser plate to spread hydrodynamic load of particulate-lean water entering the manifold tank.

3. The filtration unit of claim 2, further comprising a plurality of filter module ingress conduits, wherein each filter module ingress conduit of the plurality of filter module ingress conduits is configured to provide the particulate-lean water from the manifold tank to a respective filtration module of the at least one filtration module, wherein each filter module ingress conduit is coupled to the respective filtration module and is readily decoupleable therefrom.

4. The filtration unit of claim 1, further comprising a flocculent dosing pump inside the housing, wherein the flocculent dosing pump is configured to add flocculent to the pressurized source of particulate-heavy water.

5. The filtration unit of claim 4, further comprising a treatment chemical dosing pump inside the housing, wherein the treatment chemical dosing pump is configured to add treatment chemicals to the pressurized source of particulate-heavy water to offset changes in pH of the particulate-heavy water due to the addition of flocculent so as to generally maintain the pH of the particulate-heavy water.

6. (canceled)

7. The filtration unit of claim 4, further comprising a clarifier disposed between the separator and the at least one filtration module, wherein the clarifier is configured to receive the particulate-lean water from the separator, to further settle flocs therein, and to provide particulate-lean water to the at least one filtration module.

8. The filtration unit of claim 7, wherein the clarifier is a lamella clarifier.

9. The filtration unit of claim 7, further including a weir, wherein the weir is configured to receive particulate-lean water from the clarifier and provide the particulate-lean water to the at least one filtration module.

10. The filtration unit of claim 9, further including a launder, wherein the launder is configured to receive particulate-lean water from the weir to and provide the particulate-lean water to the at least one filtration module.

11. The filtration unit of claim 1, wherein the at least one filtration module comprises a plurality of filtration modules.

12. The filtration unit of claim 1, wherein the separator is a vortex separator.

13. The filtration unit of claim 10, wherein the separator, the clarifier, the weir and the launder are formed as a processing assembly for installation in the housing as a unit.

14. The filtration unit of claim 1, wherein the at least one filtration module is configured to be readily replaceable with another at least one filtration module containing fresh or regenerated porous filtration media.

15. The filtration unit of claim 1, wherein the housing comprises a container transportable using a standard shipping container.

16. The filtration unit of claim 1, further comprising a bund floor positioned intermediate the at least one filtration module and a floor of the housing, wherein the bund floor is configured to channel the filtered water to the at least one outlet conduit.

17. The filtration unit of claim 16, wherein the bund floor comprises a series of rollers, wherein the series of rollers is configured to facilitate passage of the at least one filtration module across the bund floor.

18. The filtration unit of claim 1, wherein the separator is configured to separate most particles of the particulate that are greater than about 150 microns in size.

19. (canceled)

20. (canceled)

21. A system comprising:
one or more water filtration units, wherein each water filtration unit of the one or more water filtration units comprises:
a housing,
a passive separator in the housing, wherein the passive separator is configured to:
receive a pressurized source of particulate-heavy water,
separate most of the particulate mass from the water, and
output particulate-lean water,
a particulate egress unit disposed at least partly within the housing, wherein
the particulate egress unit comprises a storage plenum and at least one of an egress conduit and an egress aperture, and
the particular egress unit is configured to receive, and allow disposal of, the particulate separated from the water,
at least one filtration module in the housing, wherein each filtration module of the at least one filtration module comprises porous filtration media, each filtration module being configured to:
receive the particulate-lean water simultaneously, and
filter remaining particulate and contaminants from the particulate-lean water by allowing passage of the water through the porous filtration media under gravity; and
at least one outlet conduit coupled to an outlet in a wall of the housing wherein each outlet conduit of the at least one outlet conduit is configured to:
receive filtered water from the filtration modules, and
provide the filtered water to a fluid sink outside the housing; and
a pump configured to provide the pressurised source of particulate-heavy water to the one or more water filtration units.

22. A method for filtering water, comprising:
receiving, by a passive separator of a water filtration unit, a pressurized source of particulate-heavy water;
adding, by the water filtration unit, a flocculant to the particulate-heavy water;
separating, by the passive separator, most of the particulate mass from the particulate-heavy water to obtain particulate-lean water;
outputting, by the passive separator, to an egress unit disposed at least partly in a housing of the water filtration unit, the particulate-lean water, wherein the egress unit comprises a storage plenum and at least one of a particulate conduit and a particulate aperture;
receiving, at the egress unit, the particulate mass, where in the egress unit is configured to allow disposal of the particulate mass;
receiving, at a filtration module of the water filtration unit, the particulate-lean water;
filtering, by a porous filtration media of the filtration module, remaining particulate and contaminants from the particulate-lean water, wherein the particulate-lean water is filtered by allowing passage of the particulate-lean water through the porous filtration media under gravity;
receiving, at one or more outlet conduits, filtered water output by the filtration module, wherein the one or more outlet conduits are disposed in a wall of the housing; and
providing, by the one or more outlet conduits, the filtered water to a fluid sink outside the housing.
